(19) United States
(12) Patent Application Publication
(10) Pub. No.: US 2005/0117059 A1
(43) Pub. Date: Jun. 2, 2005

(54) Video-processing apparatus

(75) Inventors: Emmanuel Johannes Hubertus Smits, Eindhoven (NL); Boris Djapic, Eindhoven (NL); Kadari Subbarao Sudeendra Thirtha Koushik, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philip Electronics, BA Eindhoven (NL)

(21) Appl. No.: 10/503,251

(22) PCT Filed: Jan. 20, 2003
(86) PCT No.: PCT/IB03/00129

(30) Foreign Application Priority Data
Feb. 4, 2002 (EP) 02075439.6

(51) Int. Cl. H04N 5/46

(52) U.S. Cl. 348/558; 348/555

(57) ABSTRACT

A video-processing apparatus (9) comprises a single input set (10) comprising input connectors (11, 12, 13, 14, 15) for receiving a video signal (S) having a format selected from a plurality of potential formats; video signal processing circuitry (101; 102) which is capable of processing each of the plurality of potential video formats; and synchronization signal analyzing circuitry (30; 60) arranged to analyze any synchronization signals incorporated in the video signal (S) to determine the format of the video signal (S) actually received at the single input set (10). The synchronization signal analyzing circuitry is arranged to adapt the video signal processing circuitry (101; 102) in conformity with the format of the video signal actually received at the single input set.

The present invention relates in general to a video-processing apparatus, more particularly a display apparatus, which is capable of receiving and processing analog video signals in any format from various sources.

As will be known to persons skilled in the art, there are numerous HDTV formats. A video-processing apparatus will process these different signals in a different manner, in accordance with the actual format of the signal applied to the input of such processing apparatus. Thus, some settings of the video-processing apparatus must be adapted to the nature of the input signal;

In the prior art, the user of the apparatus must adapt these settings himself. This implies, on the one hand, that the user must be aware of the nature of the input signals, and, on the other hand, it requires specific actions to be performed by the user. Since it is not always immediately evident what format is received, it will be quite difficult for the average consumer to get the settings right.

Thus, in order to improve the user-friendliness of a video-processing apparatus, an important object of the present invention is to provide a video-processing apparatus which is capable of automatically adapting its own settings, without the user needing to know what type of signal (ED, SD, HD) he is dealing with. To this end, the invention is defined by the independent claims. The dependent claims define advantageous embodiments.

Prior-art apparatuses comprise a plurality of sets of input connectors, so that a user must select the correct set of connectors for plugging in a connecting cable to a signal source. According to one important aspect of the present invention, a video-processing apparatus comprises a single common set of input connectors, to be used by the user for plugging in a connecting cable to any signal source, such that the input signal in an input stage of the video-processing apparatus may have any format.

According to another important aspect of the present invention, the video-processing apparatus comprises synchronization signal analyzing means for automatically examining the input signal so as to effectively detect the format of the input signal, and setting control means for adapting the settings of signal processing means in accordance with the detected format.

It is noted that U.S. Pat. No. 6,108,046 describes an apparatus for automatic detection of HDTV video format. However, this publication only deals with digital signals carrying coded information regarding the format. In such a case, the apparatus only needs to read (and decode) the corresponding information available in the signal. In the case of analog video signals, no such information is available.

These and other aspects, features and advantages of the present invention will be further explained in the following description of a preferred embodiment of the video-processing apparatus according to the present invention with reference to the drawings, in which identical reference numerals indicate the same or similar parts, and in which:

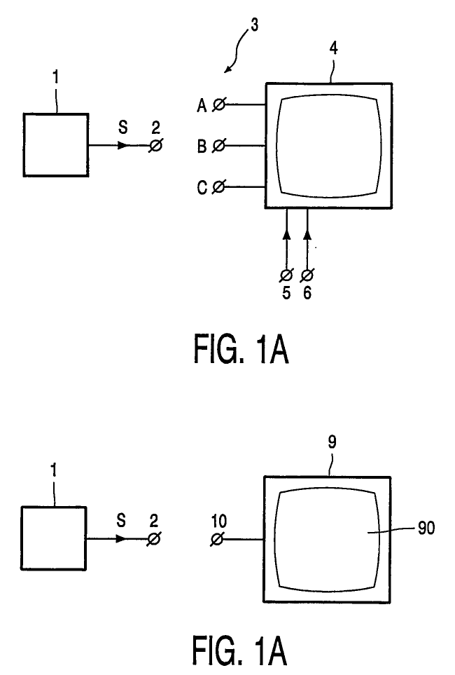

FIG. 1A schematically shows a conventional arrangement of a video signal source and a monitor;

FIG. 1B schematically shows an inventive arrangement of a video signal source and a signal-processing apparatus in accordance with the present invention;

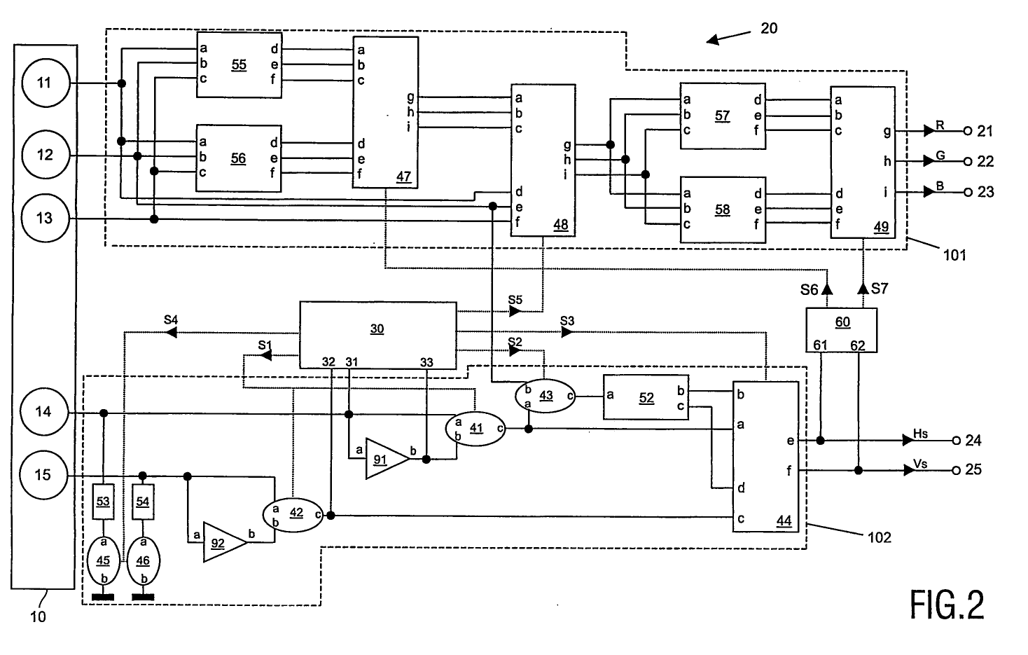

FIG. 2 is a functional block diagram of an automatic input stage of the video-processing apparatus in accordance with the present invention;

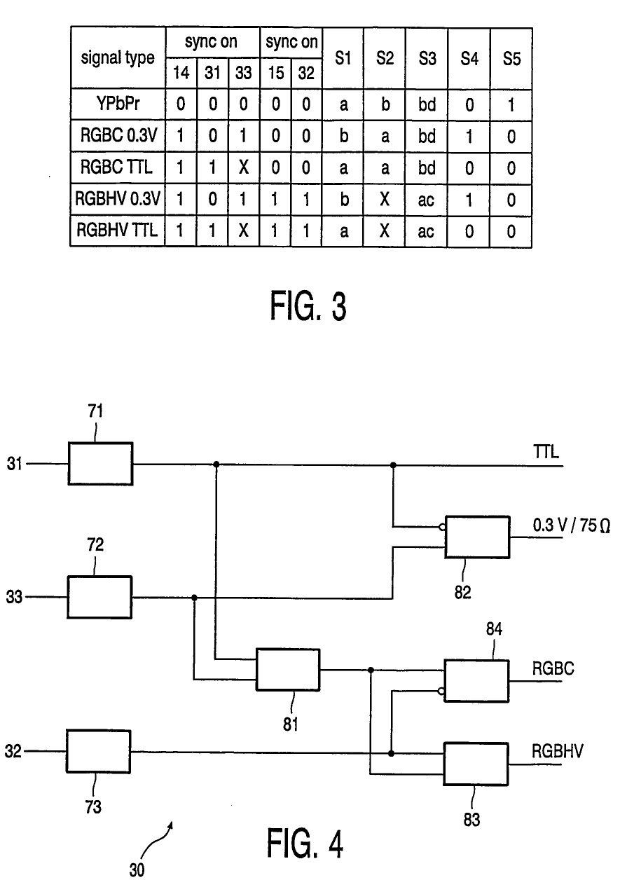

FIG. 3 is a table indicating operative states; and

FIG. 4 schematically shows a possible embodiment of a sync analyzer.

FIG. 1A schematically shows a video signal source 1 which produces an analog HD video signal S. The video signal S is a complicated signal, comprising, inter alia, color information signals, a brightness information signal, and synchronization information signals. These signals can be combined in different ways, namely:
1] three separate color signals R, G, B for the colors red, green, blue, respectively, one dedicated horizontal synchronization signal Hs, and one dedicated vertical synchronization signal Vs. This situation will hereinafter be indicated as RGBHV signal; such a signal needs five separate lines for conveying the signal.
2] three separate color signals R, G, B for the colors red, green, blue, respectively, and one combined horizontal and vertical synchronization signal Cs. This situation will hereinafter be indicated as RGBC signal; such a signal needs four separate lines for conveying the signal.
3] three derived signals Y, Pb, Pr, wherein the signal Y comprises black/white information as well as the horizontal and vertical synchronization signals, and wherein the signals Pb and Pr comprise the information for the colors red, green, blue. This situation will hereinafter be indicated as YPbPr signal; such a signal needs three separate lines for conveying the signal.

The source 1 has a set 2 of output connectors. The number of output connectors depends on the type of signal, and corresponds to the number of lines needed for conveying the signal. Thus, in the case of the RGBHV signal, the source 1 has a set 2 of five output connectors; in the case of the RGBC signal, the source 1 has a set 2 of four output connectors; and in the case of the YPbPr signal, the source 1 has a set 2 of three output connectors.

Furthermore, in the case of external synchronization signals Hs and Vs or Cs, respectively, the synchronization signals may either have a relatively large magnitude of 5 V (TTL type), or a relatively low magnitude of 0.3V, in which case the signals need a 75 Ω termination resistor to ground (0.3V/75Ω type).

The video signal S may have different line frequencies, i.e. 15 kHz or 30 kHz/45 kHz/60 kHz (indicated as 1fH and 2fH, respectively).

FIG. 1A also shows, schematically, a prior-art monitor 4 as an example of a video-processing apparatus, which is capable of processing the RGBHV signal, the RGBC signal and the YPbPr signal, if the source 1 is adequately connected to the monitor 4. To this end, the prior-art monitor has a plurality of sets 3 of input connectors. A first set of input connectors 3A has five input connectors for connection to the five output connectors of a source supplying an RGBHV signal. A second set of input connectors 3B has four input connectors for connection to the four output connectors of a source supplying an RGBC signal. A third set of input connectors 3C has three input connectors for connection to the three output connectors of a source supplying a YPbPr signal. Furthermore, in the case of external synchronization signals Cs or Hs/Vs, a user needs to know the type of synchronization signals (TTL type; 0.3V/75Ω type) and adjust a setting of the prior-art monitor accordingly, which is schematically represented as a synchronization type input 5. A user also needs to know the type of line frequency (1fH; 2fH) and adjust a setting of the prior-art monitor accordingly, which is schematically represented as a line frequency type input 6.

FIG. 1B is a schematic diagram similar to FIG. 1A, showing the source 1 and a video-processing apparatus 9 which, in accordance with the present invention, has only one single set 10 of five input connectors 11, 12, 13, 14, 15 for receiving and processing the RGBHV signal, the RGBC signal and the YPbPr signal. The inventive apparatus 9, typically a monitor, will automatically adapt its settings on the basis of characteristics of the synchronization signals of the video signal S, as will be explained hereinafter. If the video processing apparatus 9 does not have to be compatible with all mentioned types of formats of video signals; the set 10 may comprise less connectors. On the other hand when a format requires more connectors the set 10 may be expanded.

FIG. 2 is a functional block diagram of an automatic input stage 20 of the inventive video-processing apparatus 9, including the common input set 10 comprising said five input connectors 11, 12, 13, 14, 15.

The first input connector 11 is intended for connection to a Pr output connector in the case of a source providing a YPbPr signal, or for connection to an R output connector in the case of an RGBHV or RGBC signal.

The second input connector 12 is intended for connection to a Y output connector in the case of a source providing a YPbPr signal, or for connection to a G output connector in the case of an RGBHV or RGBC signal.

The third input connector 13 is intended for connection to a Pb output connector in the case of a source providing a YPbPr signal, or for connection to a B output connector in the case of an RGBHV or RGBC signal.

The fourth input connector 14 is intended for connection to a Cs output connector in the case of a source providing an RGBC signal, or for connection to a Hs output connector in the case of an RGBHV signal.

The fifth input connector 15 is intended for connection to a Vs output connector in the case of an RGBHV signal.

The input stage 20 comprises video signal processing circuitry 101, 102, comprising processing circuitry 101 for processing image information signals, and processing circuitry 102 for processing synchronization signals.

A first controllable switch 41 has a first input 41a coupled to the fourth input connector 14 and a second input 41b connected to an output 91b of a first level converter 91, whose input 91a is also connected to the fourth input connector 14. A second controllable switch 42 has a first input 42a coupled to the fifth input connector 15 and a second input 42b connected to an output 92b of a second level converter 92, whose input 92a is also connected to the fifth input connector 15. Each level converter 91, 92 is adapted to provide a TTL level signal at its respective output 91b, 92b if a 0.3 Vpp/75Ω signal is applied at its respective input 91a, 92a. Since such level converters are known per se, and such known level converters can be used here, the design and construction of level converters 91, 92 will not be discussed in detail.

In a first operative state of the first controllable switch 41, an output 41c of the first controllable switch 41 is coupled to its first input 41a, whereas in a second operative state of the first controllable switch 41, said output 41c of the first controllable switch 41 is coupled to its second input 41b. Similarly, in a first operative state of the second controllable switch 42, an output 42c of the second controllable switch 42 is coupled to its first input 42a, whereas in a second operative state of the second controllable switch 42, said output 42c of the second controllable switch 42 is coupled to its second input 42b.

The two controllable switches 41 and 42 are controlled by a first control signal S1, as will be explained hereinafter.

For assessing the type of signal and the type of synchronization signal, video-processing apparatus 9 comprises a sync analyzer 30 having three inputs 31, 32, 33. A first input 31 is connected to the fourth input connector 14. A second input 32 is connected to the output 42c of the second controllable switch 42. A third input 33 is connected to the output 91b of the first level converter 91. The sync analyzer 30 is adapted to detect, on the one hand, whether any synchronization signals are present at the fourth input connector 14 and the fifth input connector 15, and to detect, on the other hand, whether such signals, if any, are of the TTL type or the 0.3V/75Ω type. FIG. 3 shows a truth table for the possible situations, and FIG. 4 is a schematic block diagram illustrating how the sync analyzer 30 may analyze its input signals.

In the case of a YPbPr signal, synchronization signals are only present at the second input connector 12, i.e. no synchronization signals are present at the fourth input connector 14 and the fifth input connector 15, indicated by zeros in the corresponding entries on the first line of FIG. 3. Thus, sync analyzer 30 will detect no synchronization signals at its three inputs 31, 32, 33, indicated by zeros in the corresponding entries on the first line of FIG. 3.

In the case of an RGBC signal, synchronization signals are only present at the fourth input connector 14, indicated by “1” in the second and third lines of the “14” column of FIG. 3 and “0” in the second and third lines of the “15” column of FIG. 3. Irrespective of the operative mode of the second controllable switch 42, there are no synchronization signals present at its output 42c, indicated by “0” in the second and third line of the “32” column of FIG. 3. If the synchronization signals are of the 0.3V/75Ω type, the sync analyzer 30 will not detect them at its first input 31, indicated by “0” on the second line of the “31” column of FIG. 3, but sync analyzer 30 will detect synchronization signals at its third input 33, indicated by “1” on the second line of the “33” column of FIG. 3. If the synchronization signals are of the TTL type, the sync analyzer 30 will detect them at its first input 31, indicated by “1” on the third line of the “31” column of FIG. 3. The sync analyzer 30 may also detect synchronization signals at its third input 33, but this is now irrelevant, indicated by “X” on the third line of the “33” column of FIG. 3.

In the case of an RGBHV signal, synchronization signals are present at both the fourth input connector 14 and the fifth input connector 15, indicated by “1” on the fourth and fifth lines of the “14” and “15” columns of FIG. 3. If the synchronization signals are of the 0.3V/75Ω type, the sync analyzer 30 cannot detect synchronization signals at its first input 31, indicated by “0” on the fourth line of the “31” column of FIG. 3, but sync analyzer 30 will detect synchronization signals at its third input 33, indicated by “1” on the fourth line of the “33” column of FIG. 3. Again, the sync analyzer 30 may also detect synchronization signals at its third input 33, but this is now irrelevant, indicated by “X” on the fifth line of the “33” column of FIG. 3.

If the sync analyzer 30 does detect synchronization signals at its third input 33 but does not detect synchronization signals at its first input 31, indicating that the synchronization signals are of the 0.3V/75Ω type, the sync analyzer 30 generates a first control signal S1 for the first and second controllable switches 41 and 42, such that these switches are in their second operative state, indicated by “b” on the second and fourth lines of the “S1” column of FIG. 3. In all other cases, the sync analyzer 30 generates the first control signal S1 for the first and second controllable switches 41 and 42, such that these switches are in their first operative state, indicated by “a” on the first, third and fifth lines of the “S1” column of FIG. 3.

Thus, in the case of an RGBHV signal, sync analyzer 30 will detect synchronization signals at its second input 32, whether the signals are of the 0.3V/75Ω type or the TTL type, indicated by “1” on the fourth and fifth lines of the “32” column of FIG. 3.

Thus, based on the presence of any synchronization signals at its inputs 31, 32, 33, sync analyzer 30 can determine whether a YPbPr signal is received, or an RGBC signal, or an RGBHV signal, and whether the synchronization signals are of the 0.3V/75Ω type or the TTL type. It is noted that, if synchronization signals are detected at input 32 while no signals are detected at input 31 or 33 (a situation not covered by FIG. 3), the input signal is considered to be a YPbPr signal.

FIG. 4 is a functional block diagram illustrating how assessment of the synchronization type can be implemented in a possible embodiment of sync analyzer 30.

The signal received at first input 31 is fed to a first synchronization pulse detector unit 71; an output signal of the first pulse detector unit 71 indicates the presence of TTL type synchronization pulses at the fourth input connector 14.

The signal received at third input 33 is fed to a second synchronization pulse detector unit 72; an output signal of the second pulse detector unit 72 indicates the presence of synchronization pulses at the fourth input connector 14, either the TTL type or the 0.3V/75Ω type.

The output signal of the first pulse detector unit 71 and the output signal of the second pulse detector unit 72 are supplied to a first OR operator 81.

The inverted output signal of the first pulse detector unit 71 and the output signal of the second pulse detector unit 72 are supplied to a first AND operator 82. An output signal of the first AND operator 82 indicates the presence of 0.3V/75Ω type synchronization pulses at the fourth input connector 14. Thus, the first control signal S1 can be derived from the output signal of the first AND operator 82, or the output signal of the first AND operator 82 may even be used as first control signal S1 directly, as will be clear to a person skilled in the art.

The signal received at second input 32 is fed to a third synchronization pulse detector unit 73; an output signal of the third pulse detector unit 73 indicates the presence of synchronization pulses at the fifth input connector 15, either the TTL type or the 0.3V/75Ω type.

The output signal of the third synchronization pulse detector unit 73 and the output signal of said first OR operator 81 are supplied to a second AND operator 83. An output signal of the second AND operator 83 indicates the presence of RGBHV signals.

The inverted output signal of the third synchronization pulse detector unit 73 and the output signal of said first OR operator 81 are supplied to a third AND operator 84. An output signal of the third AND operator 84 indicates the presence of RGBC signals.

In the video-processing apparatus 9 according to the invention, a processing path of the video signals received at the first, second and third input connectors 11, 12, 13 is dependent on the result of the assessment made by the sync analyzer 30. To this end, video-processing apparatus 9 comprises a number of further controllable switches controlled by output signals from the sync analyzer 30, as will be explained with reference to FIG. 2.

A third controllable switch 43 has a first input 43a coupled to the output 41c of the first controllable switch 41 and a second input 43b connected to the second input connector 12. In a first operative state of the third controllable switch 43, its output 43c is coupled to its first input 43a, whereas in a second operative state said output 43c is coupled to its second input 43b. The third controllable switch 43 is controlled by a second output signal S2 from the sync analyzer 30, such that, if sync analyzer 30 has detected a YPbPr signal, the third controllable switch 43 is in its second operative state, indicated by “b” on the first line of the “S2” column in FIG. 3, while in all other cases the third controllable switch 43 is in its first operative state. It is noted, however, that the state of third controllable switch 43 is irrelevant in the case of an RGBHV signal; therefore, an “a” is indicated on the second and third lines of the “S2” column in FIG. 3, while an “X” is indicated on the fourth and fifth lines of the “S2” column in FIG. 3.

Thus, with reference to FIG. 4, the second control signal S2 can be derived from the output signal of the third AND operator 84, or the output signal of the third AND operator 84 may even be used as second control signal S2 directly, as will be clear to a person skilled in the art.

In the case of a YPbPr signal as well as an RGBC signal, there are always horizontal and vertical synchronization signals at output 43c of the third controllable switch 43; the signals at output 43c of the third controllable switch 43 in the case of an RGBHV signal are irrelevant.

Output 43c of the third controllable switch 43 is coupled to an input 52a of a HV synchronization signal separator 52 having a first output 52b and a second output 52c. Since synchronization signal separators are known per se, and such known synchronization signal separator can be used as synchronization signal separator 52, the design and construction of separator 52 will not be discussed in detail. Here it suffices that the synchronization signal separator 52 is adapted to receive combined horizontal and vertical synchronization signals and to provide separated horizontal synchronization signals at its first output 52b and separated vertical synchronization signals at its second output 52c. Thus, in the case of a YPbPr signal as well as an RGBC signal, there are always horizontal synchronization signals at the first output 52b of the separator 52 and there are always vertical synchronization signals at the second output 52c of the separator 52; the signals at outputs 52b and 52c of the separator 52 in the case of an RGBHV signal are irrelevant.

A fourth controllable switch 44 has a first input 44a coupled to the output 41c of the first controllable switch 41 and a second input 44b coupled to the first output 52b of the separator 52. The fourth controllable switch 44 also has a third input 44c coupled to the output 42c of the second controllable switch 42 and a fourth input 44d coupled to the second output 52c of the separator 52. In a first operative state of the fourth controllable switch 44, a first output 44e of the fourth controllable switch 44 is coupled to its first input 44a, while a second output 44f is coupled to its third input 44c, whereas in a second operative state of the fourth controllable switch 44, its first output 44e is coupled to its second input 44b, while its second output 44f is coupled to its fourth input 44d.

The fourth controllable switch 44 is controlled by a third output signal S3 from the sync analyzer 30, such that, if sync analyzer 30 has detected an RGBHV signal, the fourth controllable switch 44 is in its first operative state, indicated by “ac” on the fourth and fifth lines of the “S3” column in FIG. 3, whereas in all other cases the fourth controllable switch 44 is in its second operative state, indicated by “bd” in the first, second and third lines of the “S3” column in FIG. 3. Thus, in all cases, a fourth output 24 of input stage 20 coupled to said first output 44e of fourth controllable switch 44 carries the horizontal synchronization signals Hs, while a fifth output 25 of input stage 20 coupled to said second output 44f of fourth controllable switch 44 carries the vertical synchronization signals Vs.

With reference to FIG. 4, the third control signal S3 can be derived from the output signal of the second AND operator 83, or the output signal of the second AND operator 83 may even be used as third control signal S3 directly, as will be clear to a person skilled in the art.

It is noted that the fourth controllable switch 44 is a dual switch. As will be clear to a person skilled in the art, it may be replaced by two singular switches (44abe; 44cdf) both controlled by the same control signal S3.

A fifth controllable switch 45 has an input 45a connected to one terminal of a first 75Ω resistor 53 whose other terminal is connected to the fourth input connector 14. An output 45b of the fifth controllable switch 45 is connected to ground. Similarly, a sixth controllable switch 46 has an input 46a connected to one terminal of a second 75Ω resistor 54 whose other terminal is connected to the fifth input connector 15, while an output 46b of the sixth controllable switch 46 is connected to ground.

In a first operative state, the fifth and sixth controllable switches 45 and 44 connect their outputs 45b, 46b to their inputs 45a, 46a, whereas in a second operative state these switches are “open”. The fifth controllable switch 45 and the sixth controllable switch 46 are controlled by a common fourth output signal S4 from the sync analyzer 30, such that, if sync analyzer 30 has detected a 0.3 Vpp/75 Ω level synchronization signal at the fourth input connector 14, the fifth and sixth controllable switches 45 and 46 are in their first operative state, as indicated by “1” on the second and fourth lines of the “S4” column in FIG. 3, in order to effectively connect the fourth input connector 14 and the fifth input connector 15 to ground via the first 75 Ω resistor 53 and the second 75 Ω resistor 54, respectively, whereas the fifth and sixth controllable switches 45 and 46 are in their second operative state in all other cases, as indicated by “0” on the first, third and fifth lines of the “S4” column in FIG. 3.

With reference to FIG. 4, the fourth control signal S4 can be derived from the output signal of the first AND operator 82, or the output signal of the first AND operator 82 may even be used as fourth control signal S4 directly, as will be clear to a person skilled in the art. In fact, first and fourth control signals S1 and S4 may be identical.

Since the two controllable switches 45 and 46 may be both controlled by the same control signal S4, they may be replaced by one dual switch, as will be clear to a person skilled in the art.

The video-processing apparatus 9 further comprises a first translation matrix 55 and a second translation matrix 56, each adapted to translate YPbPr signals to RGB signals, the first translation matrix 55 being arranged for NTSC signals and the second translation matrix 56 being arranged for ATSC signals. Each translation matrix 55, 56 has three inputs 55a, 55b, 55c and 56a, 56b, 56c, connected to first, second and third input connectors 11, 12, 13, respectively, for receiving the YPbPr signals. Furthermore, each translation matrix 55, 56 has three outputs 55d, 55e, 55f and 56d, 56e, 56f, respectively, for providing the RGB signals. Since such translation matrices are known per se, and such known translation matrices can be used in the present invention, the design and operation of translation matrices 55 and 56 will not be discussed in detail.

A seventh controllable switch 47 has a first set of three inputs 47a, 47b, 47c connected to outputs 55d, 55e, 55f of the first translation matrix 55, a second set of three inputs 47d, 47e, 47f connected to outputs 56d, 56e, 56f of the second translation matrix 56, and a set of three outputs 47g, 47h, 47i. In a first operative state of the seventh controllable switch 47, its set of outputs 47g, 47h, 47i is connected to its first set of three inputs 47a, 47b, 47c, respectively; in a second operative state of the seventh controllable switch 47, its set of outputs 47g, 47h, 47i is connected to its second set of three inputs 47d, 47e, 47f, respectively. Thus, in the case of a YPbPr signal received at the input 10, the outputs 47g, 47h, 47i of the seventh controllable switch 47 always carry RGB signals, either in accordance with the NTSC format or in accordance with the ATSC format, depending on the operative state of the seventh controllable switch 47. The control of the seventh controllable switch 47 will be described hereinafter.

An eighth controllable switch 48 has a first set of three inputs 48a, 48b, 48c connected to outputs 47g, 47h, 47i of the seventh controllable switch 47, a second set of three inputs 48d, 48e, 48f connected to first, second and third input connectors 11, 12, 13, respectively, and a set of three outputs 48g, 48h, 48i. In a first operative state of the eighth controllable switch 48, its set of outputs 48g, 48h, 48i is connected to its first set of three inputs 48a, 48b, 48c, respectively, in a second operative state of the eighth controllable switch 48, its set of outputs 48g, 48h, 48i is connected to its second set of three inputs 48d, 48e, 48f, respectively.

The eighth controllable switch 48 is controlled by a fifth output signal S5 from the sync analyzer 30, such that, if sync analyzer 30 has detected a YPbPr signal received at the input 10, the eighth controllable switch 48 is in its first operative state, indicated by “1” on the first line of the “S5” column in FIG. 3, whereas the eighth controllable switch 48 is in its second operative state in all other cases, indicated by “0” on the second to fifth lines of the “S5” column in FIG. 3.

Thus, the outputs 48g, 48h, 48i of the eighth controllable switch 48 always carry RGB signals, either originating from one of the translation matrices 55, 56, or directly originating from input 10, depending on the operative state of the eighth controllable switch 48 as controlled by the sync analyzer 30.

It is noted that the eighth controllable switch 48 is a triplicate switch; as will be clear to a person skilled in the art, it may be replaced by three singular switches controlled by one common control signal S5.

With reference to FIG. 4, the fifth control signal S5 can be derived by suitably combining the output signals of second AND operator 83 and third AND operator 84, for instance by performing a NOR operation on the output signals of second AND operator 83 and third AND operator 84, as will be clear to a person skilled in the art.

The video-processing apparatus 9 further comprises a first video signal processing block 57 arranged to process RGB signals having a line frequency of 15 kHz (1fH), and a second video signal processing block 58 arranged to process RGB signals having a line frequency of 30 kHz/45 kHz/60 kHz (2fH). Since such processing blocks are known per se, and such known blocks may be used in the present invention, their operation and design will not be discussed in detail.

The first and second video signal processing blocks 57 and 58 have inputs 57a, 57b, 57c and 58a, 58b, 58c, respectively, connected to the outputs 48g, 48h, 48i of the eighth controllable switch 48, in order to receive the RGB signals. The video-processing apparatus 9 further comprises a ninth controllable switch 49 having a first set of three inputs 49a, 49b, 49c connected to outputs 57d, 57e, 57f of the first video signal processing block 57, a second set of three inputs 49d, 49e, 49f connected to outputs 58d, 58e, 58f of the second video signal processing block 58, and a set of three outputs 49g, 49h, 49i, connected to respective outputs 21, 22, 23. In a first operative state of the ninth controllable switch 49, its set of outputs 49g, 49h, 49i is connected to its first set of three inputs 49a, 49b, 49c, respectively; in a second operative state of the ninth controllable switch 49, its set of outputs 49g, 49h, 49i is connected to its second set of three inputs 49d, 49e, 49f, respectively.

It is noted that the ninth controllable switch 49 is a triplicate switch; as will be clear to a person skilled in the art, it may be replaced by three singular switches controlled by one common control signal.

For controlling the seventh controllable switch 47 and the ninth controllable switch 49, the monitor 9 comprises a second sync analyzer 60 having two inputs 61 and 62 connected to the fourth output 24 and the fifth output 25, respectively. The second sync analyzer 60 is adapted to determine the line frequency of the input video signal S by analyzing the horizontal and vertical synchronization signals Hs and Vs as derived from the input video signal S. In an example of an embodiment, the second sync analyzer 60 is adapted to determine the line frequency of the input video signal S by counting the number of horizontal synchronization pulses between successive vertical synchronization pulses, as will be clear to a person skilled in the art. Based on the result of this determination, the second sync analyzer 60 generates a suitable control signal S6 for the seventh controllable switch 47 so as to effectively select the NTSC matrix or the ATSC matrix, and the second sync analyzer 60 generates a suitable control signal S7 for the ninth controllable switch 49 so as to effectively select 1fH processing or 2fH processing.

More particularly, if the second sync analyzer 60 determines that the input signal corresponds to High Definition format (HD), for instance 1080i, 720p, 960p, the second sync analyzer 60 controls the seventh controllable switch 47 so as to select the ATSC matrix. In all other cases, i.e. if the second sync analyzer 60 determines that the input signal corresponds to Enhanced Definition format (ED), for instance 480p, 576p, or if the second sync analyzer 60 determines that the input signal corresponds to Standard Definition format (SD), for instance 480i (NTSC) or 576p (PAL), the second sync analyzer 60 controls the seventh controllable switch 47 so as to select the NTSC matrix.

If the second sync analyzer 60 determines that the input signal corresponds to Standard Definition format (SD), the second sync analyzer 60 controls the ninth controllable switch 49 so as to select 1fH processing. In all other cases, i.e. if the second sync analyzer 60 determines that the input signal corresponds to Enhanced Definition format, or if the second sync analyzer 60 determines that the input signal corresponds to High Definition format, the second sync analyzer 60 controls the ninth controllable switch 49 so as to select 2fH processing.

Thus, the first, second and third outputs 21, 22, 23 always carry RGB signals, automatically processed in accordance with the correct format, and the fourth and fifth outputs 24, 25 always carry horizontal and vertical synchronization signals Hs and Vs, respectively, such that the video signals at the five outputs 21-25 are suitable for supply to a display device 90 of the monitor 9.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A video-processing apparatus (9) comprising:
a single input set (10) comprising input connectors (11, 12, 13, 14, 15) for receiving a video signal (S) having a format selected from a plurality of potential formats;
video signal-processing means (101; 102) which are capable of processing each of said plurality of potential video formats; and
synchronization signal analyzing means (30; 60) for analyzing any synchronization signals incorporated in the video signal (S) to determine the format of the video signal (S) actually received at the single input set (10), to adapt said video signal-processing means (101; 102) to the format of the video signal (S) actually received at the single input set (10).

2. A video-processing apparatus as claimed in claim 1, wherein said signal processing means (101, 102) comprise:
a first level converter (91) having an input (91a) connected to a fourth input connector (14), adapted to convert 0.3 Vpp/75Ω signals to TTL level signals,
said synchronization signal analyzing means (30; 60) comprising a first sync analyzer (30) having inputs (31, 33) coupled to said fourth input connector (14) and an output (91b) of said first level converter (91), respectively.

3. A video-processing apparatus as claimed in claim 2, wherein said signal processing means (101, 102) comprise:
a first controllable switch (41) having a first input (41a) coupled to the fourth input connector (14) and a second input (41b) coupled to said output (91b) of said first level converter (91), and an output (41c) selectively connectable to said first input (41a) or said second input (41b);
a third controllable switch (43) having a first input (43a) coupled to said output (41c) of said first controllable switch (41), a second input (43b) coupled to a second input connector (12), and an output (43c) selectively connectable to said first input (43a) or said second input (43b); and
a HV synchronization signal separator (52) having an input (52a) coupled to the output (43c) of said third controllable switch (43),
said first sync analyzer (30) being adapted to generate a control signal (S2) controlling said third controllable switch (43) to connect its output (43c) to its second input (43b) if said first sync analyzer (30) determines that no synchronization signals are received at its two inputs (31, 33).

4. A video-processing apparatus as claimed in claim 3, wherein said signal processing means (101, 102) comprise:
a second level converter (92) having an input (92a) connected to a fifth input connector (15), adapted to convert 0.3 Vpp/75Ω signals to TTL level signals; and
a second controllable switch (42) having a first input (42a) coupled to the fifth input connector (15) and a second input (42b) coupled to an output (92b) of said second level converter (92), and an output (42c) selectively connectable to said first input (42a) or said second input (42b),
said first sync analyzer (30) having an input (32) coupled to said output (42c) of said second controllable switch (42).

5. A video-processing apparatus as claimed in claim 4, wherein said signal processing means (101, 102) comprise:
a fourth controllable switch (44) having a first input (44a) coupled to said output (41c) of said first controllable switch (41), a second input (44b) coupled to a first output (52b) of said synchronization signal separator (52), a third input (44c) coupled to said output (42c) of said second controllable switch (42), a fourth input (44d) coupled to a second output (52c) of said synchronization signal separator (52), a first output (44e) selectively connectable to said first input (44a) or said second input (44b), and a second output (44f) selectively connectable to said third input (44c) or said fourth input (44d),
said first sync analyzer (30) being adapted to generate a control signal (S3) controlling said fourth controllable switch (44) to connect its outputs (44e, 44f) to its first and third inputs (44a, 44c), respectively, if said first sync analyzer (30) determines that synchronization signals are received at the fourth and fifth input connectors (14, 15).

6. A video-processing apparatus as claimed in claim 2, wherein said signal processing means (101, 102) comprise:
a fifth controllable switch (45) having a first input (45a) coupled to a first terminal of a first resistor (53) and a second input (45b) coupled to ground, the first resistor (53) having a second terminal coupled to said fourth input connector (14); and
a sixth controllable switch (46) having a first input (46a) coupled to a first terminal of a second resistor (54) and a second input (46b) coupled to ground, the second resistor (54) having a second terminal coupled to said fifth input connector (15),
said first sync analyzer (30) being adapted to generate control signals (S4) controlling said fifth and sixth controllable switches (45; 46) to connect their output (45b; 46b) to their input (45a; 46a) if said first sync analyzer (30) determines that low level type synchronization signals are received at the fourth input connector (14).

7. A video-processing apparatus as claimed in claim 2, wherein said signal processing means (101, 102) comprise:
an eighth controllable switch (48) having a first set of three inputs (48a, 48b, 48c), a second set of three inputs (48d, 48e, 48f), and a set of three outputs (48g, 48h, 48i), the second set of three inputs (48d, 48e, 48f) being coupled to first, second and third input connectors (11, 12, 13), respectively,
said first sync analyzer (30) being adapted to generate a fifth control signal (S5) controlling said eighth controllable switch (48) to connect its three outputs (48g, 48h, 48i) to its second set of three inputs (48d, 48e, 48f), respectively, if said first sync analyzer (30) determines that no synchronization signals are received at its three inputs (31, 32, 33).

8. A video-processing apparatus as claimed in claim 5, wherein said synchronization signal analyzing means (30; 60) comprise a second sync analyzer (60) having inputs (61, 62) coupled to said first and second outputs (44e, 44f) of said fourth controllable switch (44), respectively.

9. A video-processing apparatus as claimed in claim 8, wherein said signal processing means (101, 102) comprise: and
a first translation matrix (55) having three inputs (55a, 55b, 55c) coupled to said first, second and third input connectors (11, 12, 13), respectively, and three outputs (55d, 55e, 55f), the first translation matrix (55) being adapted to receive YPbPr signals at its three inputs (55a, 55b, 55c) and to provide at its three outputs (55d, 55e, 55f) RGB signals translated from said YPbPr signals in accordance the NTSC format;
a second translation matrix (56) having three inputs (56a, 56b, 56c) coupled to said first, second and third input connectors (11, 12, 13), respectively, and three outputs (56d, 56e, 56f), the second translation matrix (56) being adapted to receive YPbPr signals at its three inputs (56a, 56b, 56c) and to provide at its three outputs (56d, 56e, 56f) RGB signals translated from said YPbPr signals in accordance the ATSC format; and
a seventh controllable switch (47) having a first set of three inputs (47a, 47b, 47c) coupled to said three outputs (55d, 55e, 55f) of said first translation matrix (55), respectively, a second set of three inputs (47d, 47e, 47f) coupled to said three outputs (56d, 56e, 56f) of said second translation matrix (56), respectively, and a set of three outputs (47g, 47h, 47i) coupled to said first set of three inputs (48a, 48b, 48c), respectively, of said eighth controllable switch (48),
said second sync analyzer (60) being adapted to generate a control signal (S6) controlling said seventh controllable switch (47) to connect its three outputs (47g, 47h, 47i) to its second set of three inputs (47d, 47e, 47f), respectively, if said second sync analyzer (60) determines that synchronization signals received at both its two inputs (61, 62) correspond to a HD standard, and said second sync analyzer (60) being adapted to generate a control signal controlling said seventh controllable switch (47) to connect its three outputs (47g, 47h, 47i) to its first set of three inputs (47a, 47b, 47c), respectively, in all other cases.

10. A video-processing apparatus as claimed in claim 8, wherein said signal processing means (101, 102) comprise:
a first video signal processing block (57) having three inputs (57a, 57b, 57c) for receiving and processing RGB signals having the 1fH format, and three outputs (57d, 57e, 57f) for providing processed RGB signals;
a second video signal processing block (58) having three inputs (58a, 58b, 58c) for receiving and processing RGB signals having the 2fH format, and three outputs (58d, 58e, 58f) for providing processed RGB signals; and
a ninth controllable switch (49) having a first set of three inputs (49a, 49b, 49c) coupled to said three outputs (57d, 57e, 57f) of said first video signal processing block (57), a second set of three inputs (49d, 49e, 49f) coupled to said three outputs (58d, 58e, 58f) of said second video signal processing block (58), and having three outputs (49g, 49h, 49i), and said second sync analyzer (60) being adapted to generate a control signal (57) controlling said ninth controllable switch (49) to connect its three outputs (49g, 49h, 49i) to its first set of three inputs (49a, 49b, 49c), respectively, if said second sync analyzer (60) determines that synchronization signals received at both its two inputs (61, 62) correspond to a SD standard, and said second sync analyzer (60) being adapted to generate a control signal (S7) controlling said ninth controllable switch (49) to connect its three outputs (49g, 49h, 49i) to its second set of three inputs (49d, 49e, 49f), respectively, if said second sync analyzer (60) determines that synchronization signals received at both its two inputs (61, 62) correspond to a HD standard or an ED standard.

11. A monitor (9) comprising a video-processing apparatus as claimed in claim 1 and a display device (90) for displaying an output signal of the video-processing apparatus.

12. A method of automatically adjusting a processing path for processing video signals, the method comprising the steps of:
analyzing signals to determine whether a signal (S) is received in accordance with the YPbPr format, the TTL type RGBC format, the 0.3 V/75 Ω type RGBC format, the TTL type RGBHV format, or the 0.3 V/75 Ω type RGBHV format; and
adapting a setting of signal processing means (101; 102) in accordance with the results of said determination.
